(19) United States
(12) Patent Application Publication
(10) Pub. No.: US 2008/0314112 A1
(43) Pub. Date: Dec. 25, 2008

(54) Coupling boss and method for fabricating the same

(75) Inventors: Sang Bong Park, Busan (KR); Sun Ouk Park, Busan (KR); Seong Young Lee, Changwon (KR); Sang Soon Hwang, Busan (KR); Sang Hoon Jeong, Busan (KR)

Correspondence Address: Hyun Jong Park, TUCHMAN & PARK LLC, 41 White Birch Road, Redding, CT, 06896-2209, US

(73) Assignees: Sang Bong Park, Busan (KR); DIT Co., Ltd., Busan (KR)

(21) Appl. No.: 12/145,476

(22) Filed: Jun. 24, 2008

Related U.S. Application Data
(63) Continuation of application No. PCT/KR2006/003953, filed on Oct. 2, 2006.

(30) Foreign Application Priority Data
Jan. 10, 2006 (KR) 10-2006-0002909

(51) Int. Cl. B21D 22/20; F16B 37/00

(52) U.S. Cl. 72/347; 411/427

(57) ABSTRACT

Disclosed therein are a coupling boss and a method for fabricating a coupling boss, that a collar part is formed through a collar drawing process using a metal plate material, and then, a body part of the coupling boss is firmly combined to a substrate plate through processes of deep drawing, tapping, cleansing, plating and iron coining in order, thereby maximizing competitive power in price, miniaturizing the coupling boss in size, and maximizing tensile strength, compression strength, and surface roughness. In this instance, a more stable material thickness can be kept by performing a collar drawing process or a curling process when a screw part of the coupling boss is formed. The processes of: forming a collar part (2) through a collar drawing process for forming a screw part (8) of the coupling boss (1) using a metal plate material; forming a body part (3) and a flange part (4) on the metal plate material, on which the collar part (2) is formed, through a deep drawing process; and tapping to form the screw part (8) on the inner peripheral portion of the collar part (2) and the processes of: forming a body part (3) and a flange part (4) by a deep drawing process using a metal plate material; forming a collar part (2) on the body part (3) by a curling process; and tapping to form a screw part (8) on the inner peripheral portion of the collar part (2) are performed selectively. After that, the formed coupling boss (1) is firmly combined to a substrate plate (5) through the processes of cleansing, plating, and iron coining.

### REFERENCE TO RELATED APPLICATIONS

This a continuation of pending International Patent Application PCT/KR2006/003953 filed on Oct. 2, 2006, which designates the United States and claims priorities of Korean Patent Application No. 10-2006-0002909filed on Jan. 10, 2006.

### FIELD OF THE INVENTION

The present invention relates to a coupling boss and a method for fabricating the same, and more particularly, to a coupling boss and a method for fabricating a coupling boss, that a collar part is formed through a collar drawing process using a metal plate material, and then, a body part of the coupling boss is firmly combined to a substrate plate through processes of deep drawing, tapping, cleansing, plating and iron coining in order, thereby maximizing competitive power in price, miniaturizing the coupling boss in size, and maximizing tensile strength, compression strength, and surface roughness. In this instance, a more stable material thickness can be kept by performing a collar drawing process or a curling process when a screw part of the coupling boss is formed.

### BACKGROUND OF THE INVENTION

In general, a coupling boss, which is used to assemble chassis and parts constituting various display means, is fabricated by machining its material on a lathe, or by a cold forging process on a header.

So, the prior art method for fabricating the coupling boss is expensive in fabricating cost since its fabricating process is very complicated and it takes much time and man power to fabricate it. Therefore, a plan to overcome the problems of the prior art method for fabricating the coupling boss is needed.

### SUMMARY OF THE INVENTION

Accordingly, the present invention has been made to solve the above-mentioned problems occurring in the prior arts, and it is an object of the present invention to provide a coupling boss of a new structure and a method for fabricating the same.

It is an object of the present invention is to provide a method for fabricating a coupling boss, which includes the steps of forming a collar part of the coupling boss through a collar drawing process using a metal plate material, forming through a deep drawing process and a tapping process or through the deep drawing process, a curling process and a tapping process, and combining the coupling boss to a substrate plate through a cleansing process, a plating process and an iron coining process in order, thereby maximizing competitive power in price, miniaturizing the coupling boss in size, and maximizing tensile strength, compression strength, and surface roughness.

To accomplish the above object, according to the present invention, there is provided a method for fabricating a coupling boss comprising the steps of: forming a collar part through a collar drawing process for forming a screw part of the coupling boss using a metal plate material; forming a body part and a flange part on the metal plate material on which the collar part is formed, through a deep drawing process; tapping the coupling boss to form the screw part on the inner peripheral portion of the collar part; cleansing and plating the tapped coupling boss; and firmly combining the coupling boss with a substrate plate through an iron coining process.

According to the method for fabricating a coupling boss, the collar part of the coupling boss is through the collar drawing process using the metal plate material, the screw part is formed through the deep drawing process and the tapping process or through the deep drawing process, the curling process and the tapping process, and then, the coupling boss is combined to the substrate plate passing through the cleansing process, the plating process and the iron coining process in order, whereby the present invention can maximize competitive power in price, miniaturize the coupling boss in size, and maximize tensile strength, compression strength, and surface roughness. Since the curling process is applied to form the screw part 8 of the coupling boss 1, a more stable thickness of the material can be kept.

### BRIEF DESCRIPTION OF THE DRAWINGS

FIG. 1 is a perspective view of a coupling boss according to a first preferred embodiment of the present invention.

FIG. 2 is a sectional view of the coupling boss according to the first preferred embodiment.

FIGS. 3 and 4 are process charts for fabricating the coupling boss according to the present invention.

FIGS. 5 and 6 are process charts for fabricating a coupling boss according to a second preferred embodiment of the present invention.

FIG. 7 is a sectional view for explaining an iron coining process for fixing the coupling boss and a substrate plate with each other.

FIG. 8 is a sectional view for explaining a curling process using a curling punch to form a screw-coupling part on the coupling boss according to the present invention.

FIGS. 9 to 16 are CAE analysis charts during a collar drawing process of the coupling boss fabricating process according to the present invention.

FIGS. 17 to 21 are CAE analysis charts during a deep drawing process of the coupling boss fabricating process according to the present invention.

FIGS. 22 to 24 are CAE analysis charts during an iron coining process of the coupling boss fabricating process according to the present invention.

FIGS. 25 to 27 are CAE analysis charts during a prior art forcedly pressing process of a prior art coupling boss and a substrate plate.

FIGS. 28 to 30 are CAE analysis charts of essential parts during an iron coining process of the coupling boss fabricating process according to the present invention.

FIG. 31 is an analysis chart of a tension test CAE analysis result according to the prior art forcedly pressing process of the prior art coupling boss and the substrate plate.

FIG. 32 is a graph of a tension load CAE analysis result according to the prior art forcedly pressing process of the prior art coupling boss and the substrate plate.

FIG. 33 is an analysis chart of a tension test CAE analysis result of the coupling boss according to the iron coining process of the present invention.

FIG. 34 is a graph of a tension load CAE analysis result of the coupling boss according to the iron coining process of the present invention.

FIG. 35 is a comparison table by item for comparing the present invention with the prior art.

### DETAILED DESCRIPTION OF THE INVENTION

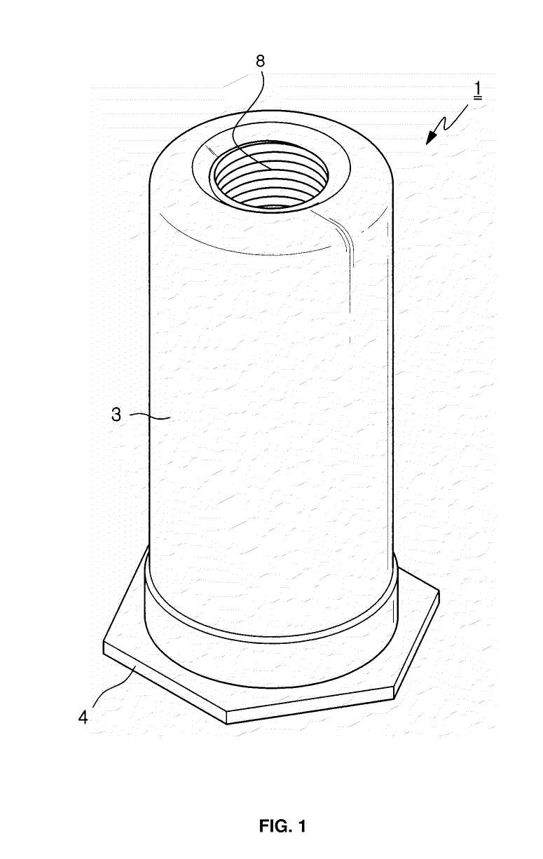

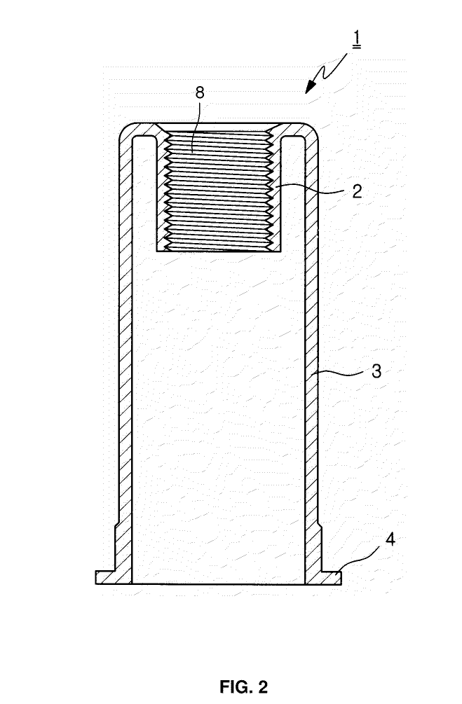

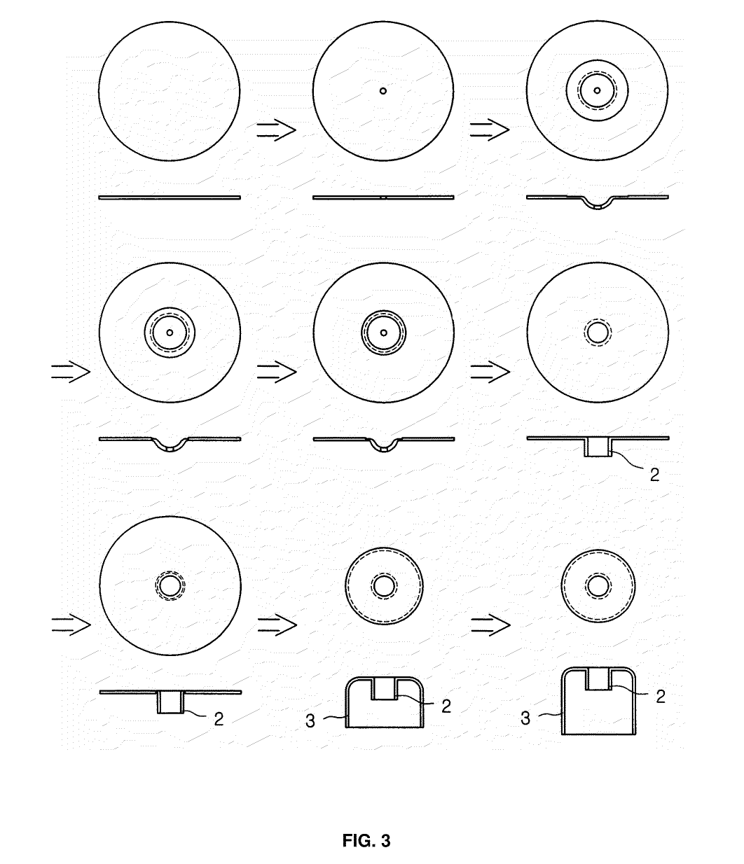

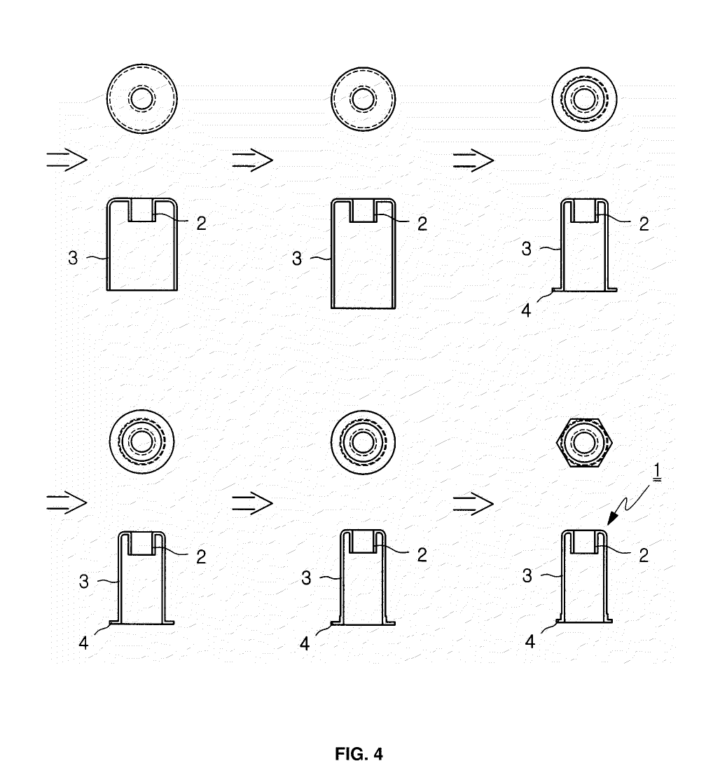

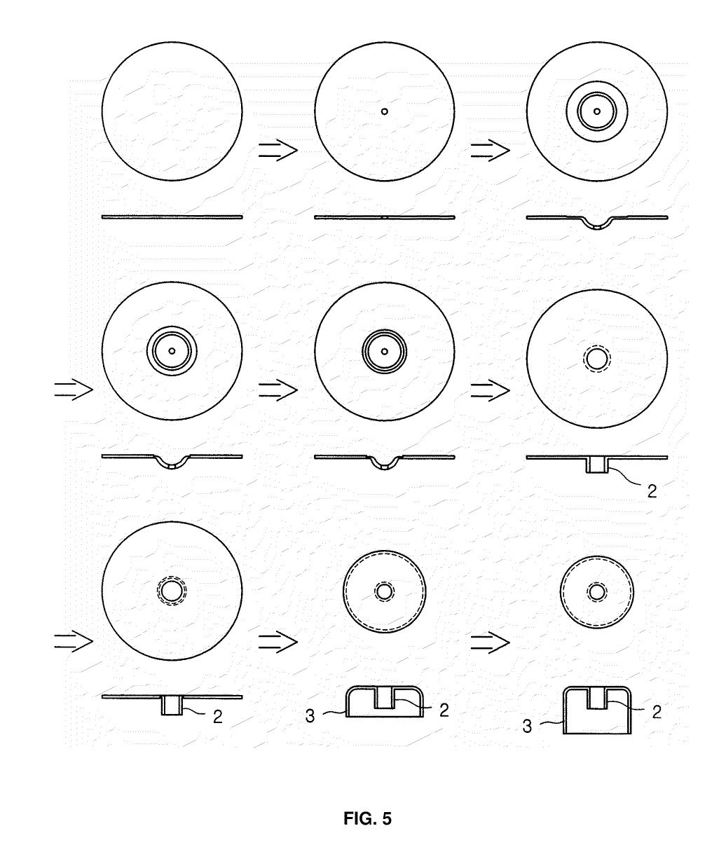

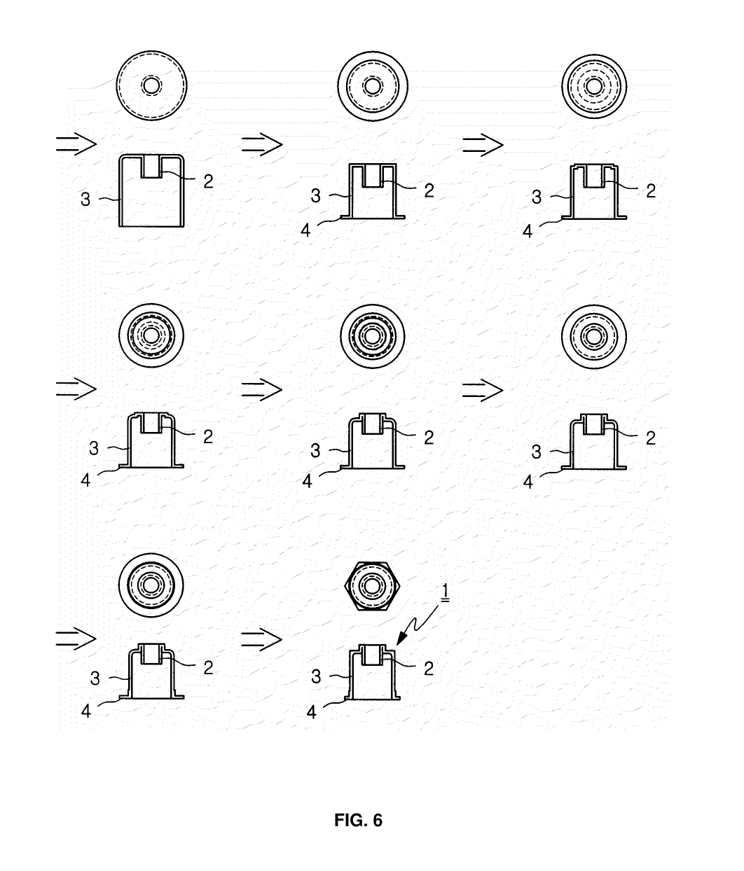

FIG. 1 is a perspective view of a coupling boss 1 according to a first preferred embodiment of the present invention, FIG. 2 is a sectional view of the coupling boss 1, and FIGS. 3, 4, 5 and 6 are process charts of the coupling boss 1 fabricated according to the present invention. Reference will be now made in detail to the preferred embodiment of the present invention with reference to the attached drawings.

The coupling boss 1 according to the present invention is completely fabricated by performing processes of collar drawing, deep drawing, tapping or deep drawing, curling, tapping, cleansing, plating, and an iron coining in order.

First, in the collar drawing process which is the first step for fabricating the coupling boss 1, a collar part 2 is easily formed by increasing the thickness of a raw material of the collar part 2 by 10% or more through punching of several steps and a series of forming on a die to provide a precise form and size of the collar part 2. After forming, the collar part 2 is completely formed thicker than the raw material.

For this, the punch and the die are designed in various shapes according to mechanical properties and chemical ingredients, such as the quality of the raw material, tensile strength, yield strength, percentage of elongation, and so on. Particularly, a forming limit and an anisotropic coefficient of material is important basic data to determine a shape clearance of the punches and dies of the above processes.

To complete the collar drawing process, proper values of a punch load and a die cushion pressure in each process are calculated through a CAE analysis.

The collar part 2 formed through the collar drawing process is used as a screw part 8 of the coupling boss 1.

The deep drawing process performed after the collar drawing process is to form a body part 3 and a flange part 4 of the coupling boss 1. The deep drawing process includes the steps of the first drawing and a re-drawing.

The main process variables for determining the deep drawing process are diameters and clearance of the punch and the die, punch load, die cushion pressure, and so on.

After the deep drawing of the body part 3, an ironing process, a re-striking process and a trimming process are performed to determine a size of the finished product.

The trimming process is the final process to form a shape to prevent rotation of the flange part 4 of the coupling boss 1.

The tapping process to form a female screw on the collar part 2 includes the following two processes.

That is, the tapping process includes a cold rolling tapping process and a machining tapping process.

A machine for the machining tapping process includes a main body and peripheral devices. A coupling boss fixing jig includes a spindle and a tapping chuck. For the peripheral devices, there are a parts feeder for precisely supplying a coupling boss intermediate material, a power transmission device, oil feeding device, a part for electricity control and power source, and an automatic inspection device.

The parts feeder conveys the coupling boss intermediate material to the coupling boss fixing jig of the main body by vibration of a vibration motor and an aligning device. The intermediate material fixed on the jig is a process system that a tap fixed on the chuck processes a coupling hole of the coupling boss by a spindle rotation and a drop of a main spindle.

The cold rolling tapping process uses the same tapping machine system as the machining tapping process, but is different from the machining tapping process according to the specification of the used taps.

The coupling boss 1 after the tapping process passes the cleansing process to remove impurities, chips and foreign matters generated during plastic working and machining process and obtain a good plating process condition.

The cleansing process includes the steps of pretreatment cleansing using wash liquid and supersonic cleansing. A cleansing period of time is about 20±15 minutes, and after performing a drying process at 100±10° C. for 10±1 minutes, a defatting process is performed. The defatting process includes a dipping process and an electrocleaning process.

The defatting process is performed to remove attached fat. After the defatting process, a water cleaning process is performed three times, and then, a 5% acid (hydrochloric acid+sulphuric acid) cleaning process is performed. The cleansing process is finished by performing the water cleaning process three times.

After the above process, the plating process is performed to the coupling boss 1 to prevent corrosion and increase strength of the finished coupling boss 1. Additionally, the plating process is essential to maintain its strength when the coupling boss 1 is combined to a substrate plate 5 by an iron coining process. The plating is classified into electroless plating and acidic zinc plating.

The electroless plating includes the steps of digging the coupling boss 1 in a plating bath for 12 to 15 minutes, water cleaning it three times after a visual inspection, water cleaning it three times again after a discoloration preventing process, centrifugally drying it at 80±10° C. for 30±5 minutes, and performing an inspection process.

The acidic zinc plating includes the steps of digging the coupling boss 1 in a plating bath for 30 minutes, water cleaning it three times, water cleaning it three times again after a surface controlling process, and performing a surface controlling process, centrifugally drying it at 80±10° C. for 30±5 minutes, and performing an inspection process.

Meanwhile, the iron coining process includes the steps of inserting the coupling boss 1 formed by the above fabricating method to the substrate plate 5, putting the substrate plate 5 on a die 6, lowering an iron coining punch 7, and combining the coupling boss 1 and the substrate plate 5 with each other by a complex forming of ironing and coining.

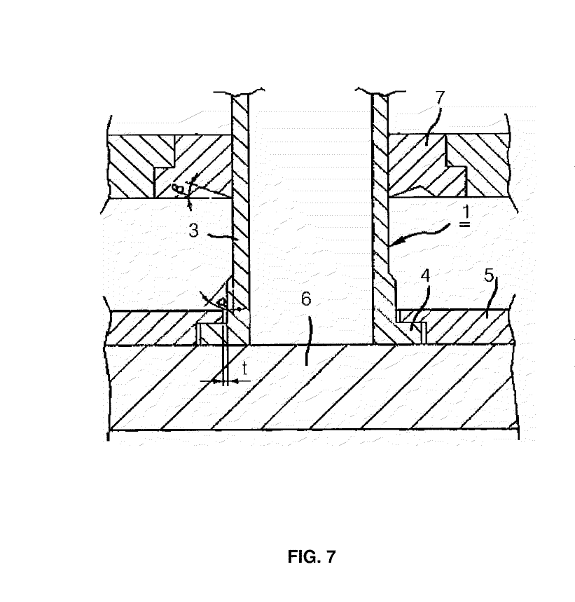

To complete the iron coining process, as shown in FIG. 7, a clearance (t) between the substrate plate 5 and the coupling boss 1 must be kept, and the size of the clearance (t) is determined according to a material quality of the coupling boss 1, a material quality of the substrate plate 5, a thickness of the substrate plate 5, a thickness of the coupling boss 1, a thickness of the flange part 4 of the coupling boss 1, and load of the iron coining punch 7.

The thickness of the flange part 4 of the coupling boss 1 is determined according to the material quality of the substrate plate 5, the material quality of the coupling boss 1, and the thickness of the substrate plate 5.

Furthermore, an iron coining introduction angle (α) is determined differently according to the material quality of the coupling boss 2 and a diameter of the coupling boss 1. The introduction angle (α) is small if the coupling boss 1 is made of a soft material, but is large if the coupling boss 1 is made of a rigid material, and in this instance, the introduction angle (α) is within the range of 0 to 90°.

An iron coining forming angle (β) is determined differently according to the material quality of the coupling boss 2 and the diameter of the coupling boss 1, and is an important variable to determine the shape of the iron coining after the completion of forming. The forming angle (β) is within the range of 0 to 45°.

An iron coining amount (namely, thickness and height) is determined according to tensile strength and compression strength required after the completion of forming. The tensile strength and the compression strength are increased after the process completion when the height and thickness are increased. But, if the tensile strength and the compression strength are too excessive, it may have an influence on an increase of forming load and lifespan of the die and mould.

The main process variables of the iron coining process are as follows:
1. clearance between the substrate plate and the coupling boss;
2. iron coining introduction angle (α);
3. iron coining forming angle (β);
4. iron coining size (thickness and height); and
5. thickness of the flange of the coupling boss.

The curling process used in the present invention is to curl-die the screw part 8 using a curling punch 9 after forming the cylindrical body part 3 of the coupling boss 1 by the deep drawing process.

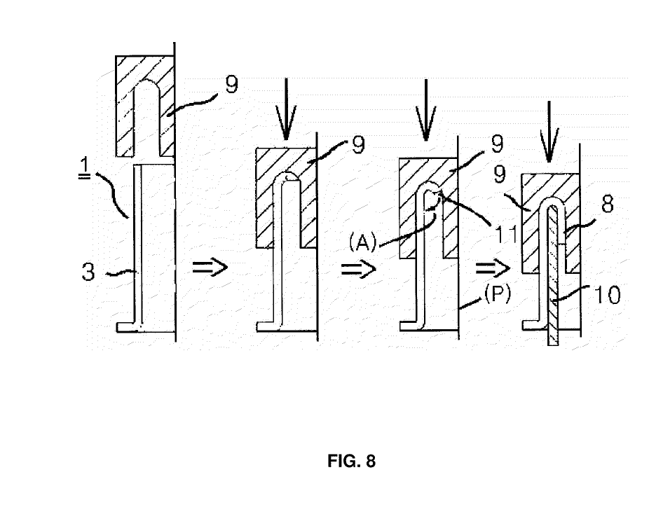

During the curling process, as shown in FIG. 8, the coupling boss 1 is continuously curled in an (A) direction, in this instance, a guide punch 10 is inserted into the cylindrical body part 3 the moment a curled portion 11 breaks away from a parallel state to a (P) axis to induce that the front end of the curled portion 11 is formed in a parallel direction to the (P) axis. Through the above process, the screw part 8 of the coupling boss 1 is completed.

The curling process has an advantage in that the thickness of the screw part 8 becomes more stable since the thickness of the screw part 8 is thicker than a thickness of a raw material of the screw part 8 by the inward curling.

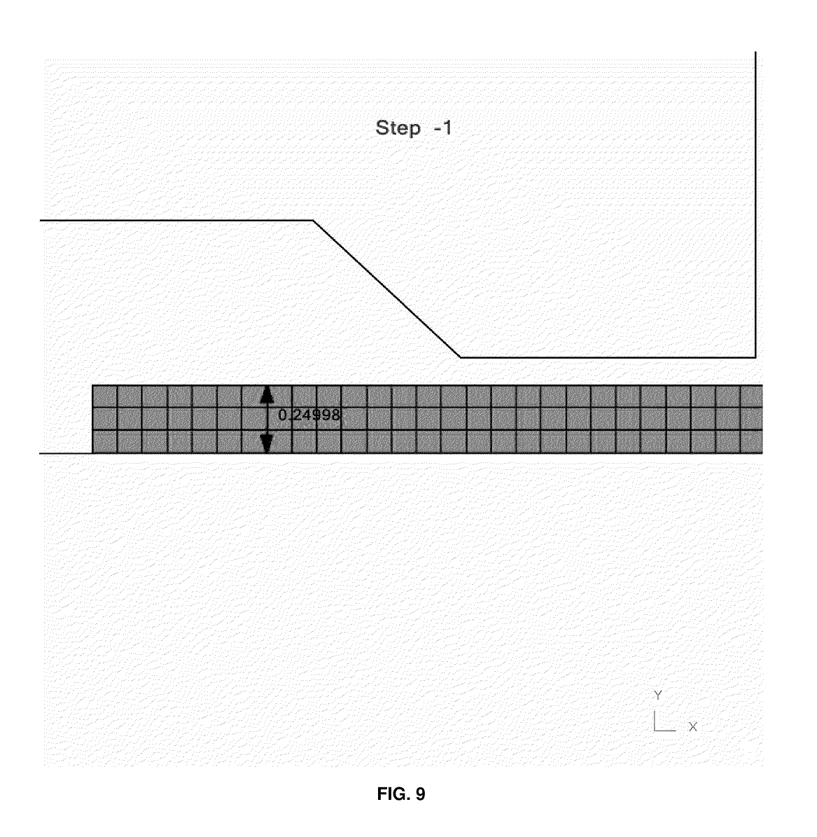

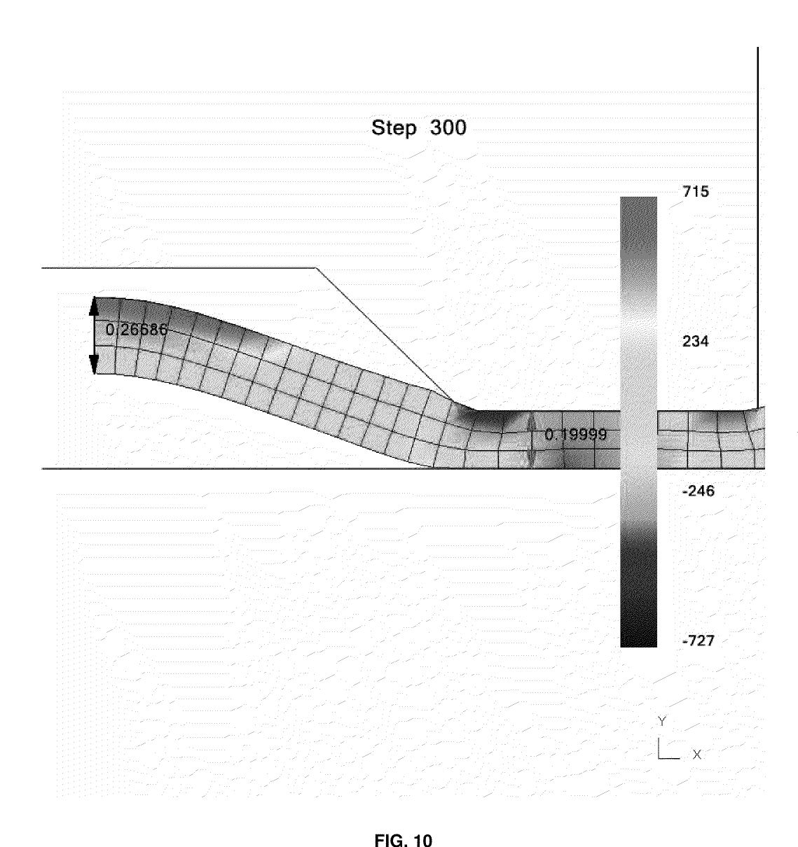

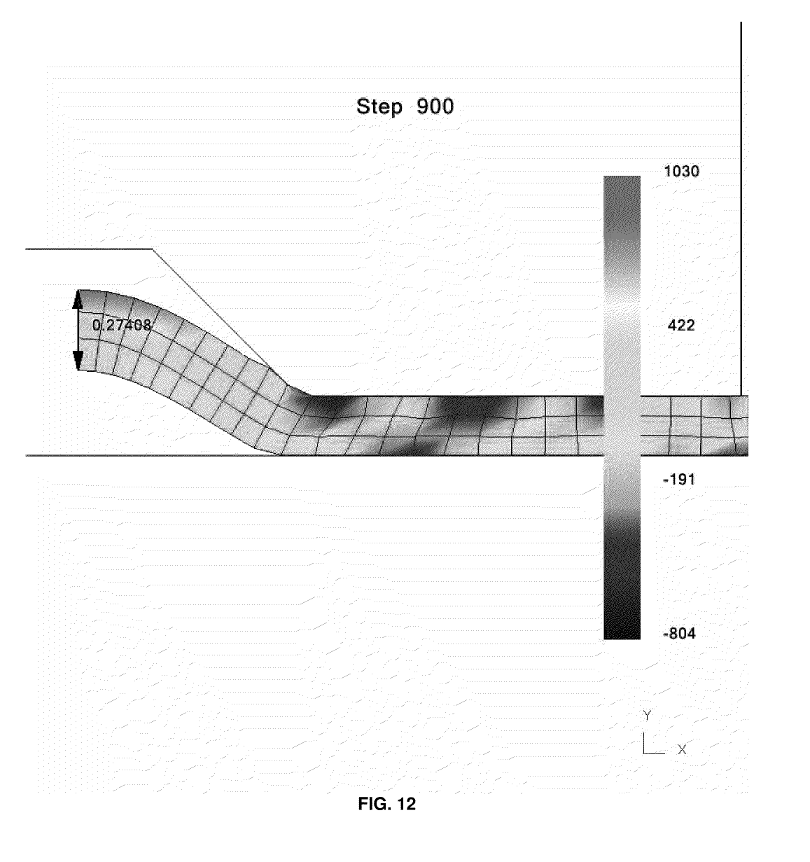

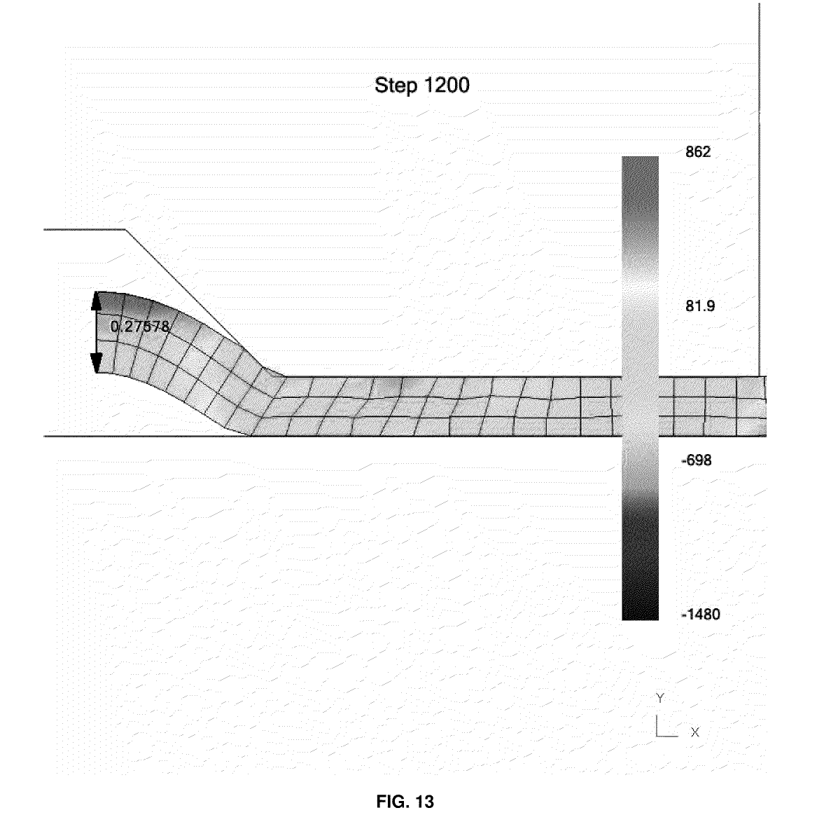

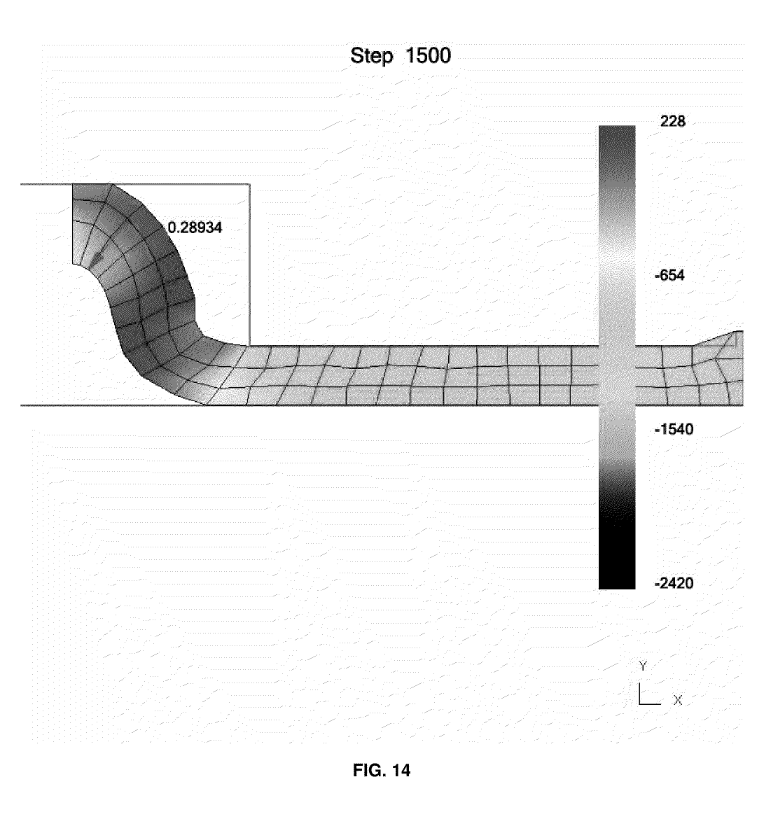

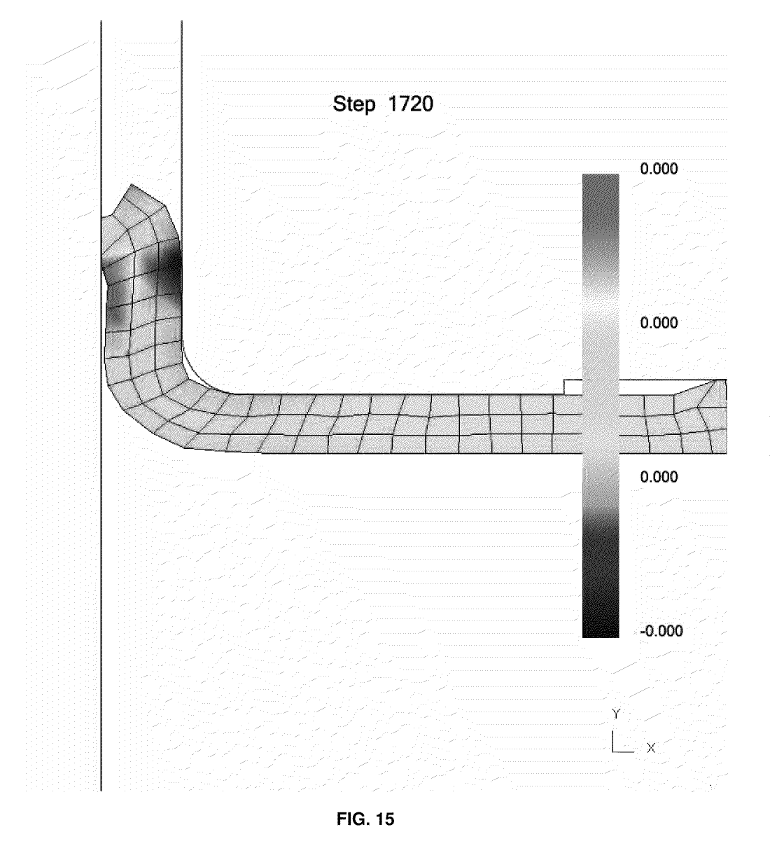

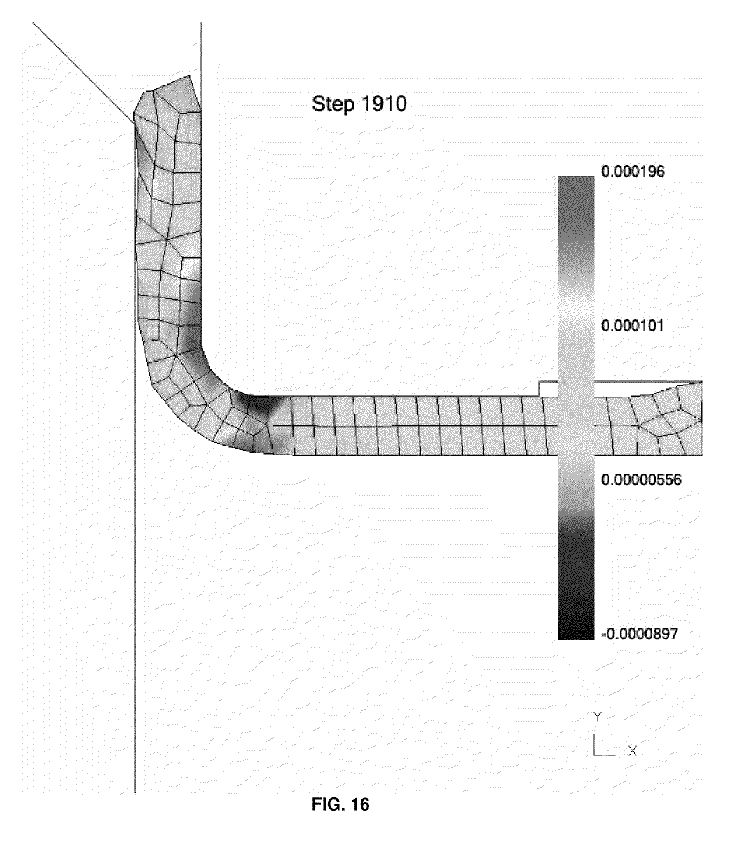

Meanwhile, FIGS. 9 to 16 are CAE analysis charts during a collar drawing process of the coupling boss fabricating process according to the present invention.

A thickness of the first plate material for the collar drawing process is 0.25 mm.

First preliminary collar drawing: as shown in FIG. 9, locally press the plate material around a collar drawing part to the punch to move a volume to the collar drawing part, whereby the collar drawing part becomes thicker.

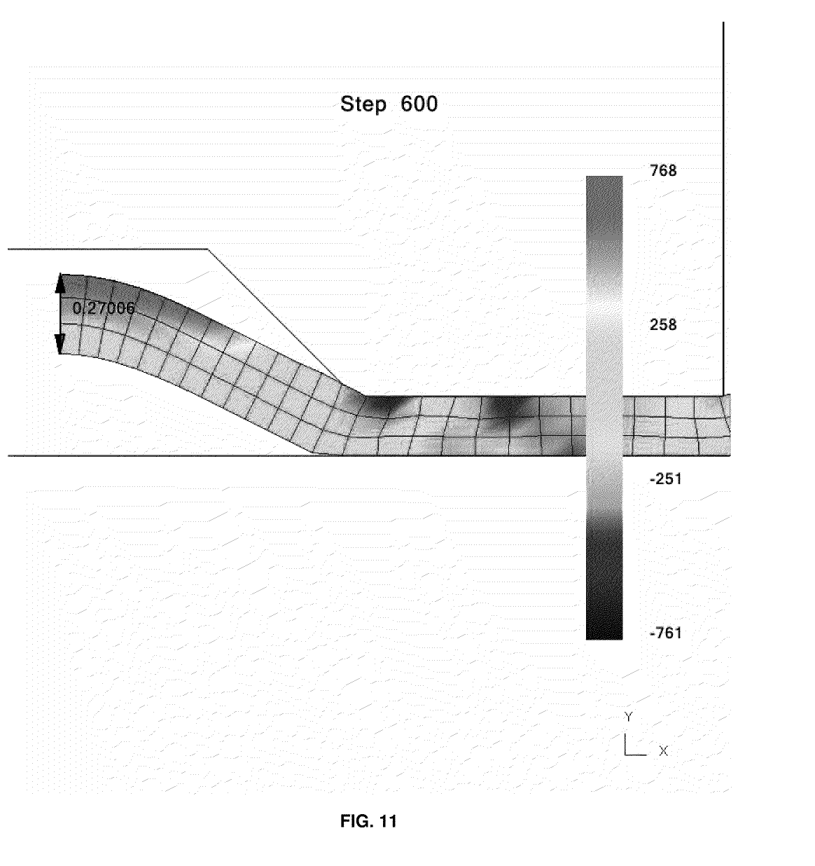

Second to fifth preliminary collar drawing: as shown in FIGS. 11 to 14, more closely contact the pressed portion to the collar drawing part using the punch and coin it to concentrate the volume on the collar drawing part.

Since the volume of the collar drawing part is increased by the first and second collar drawing processes, the collar drawing part is higher than that by the prior art process.

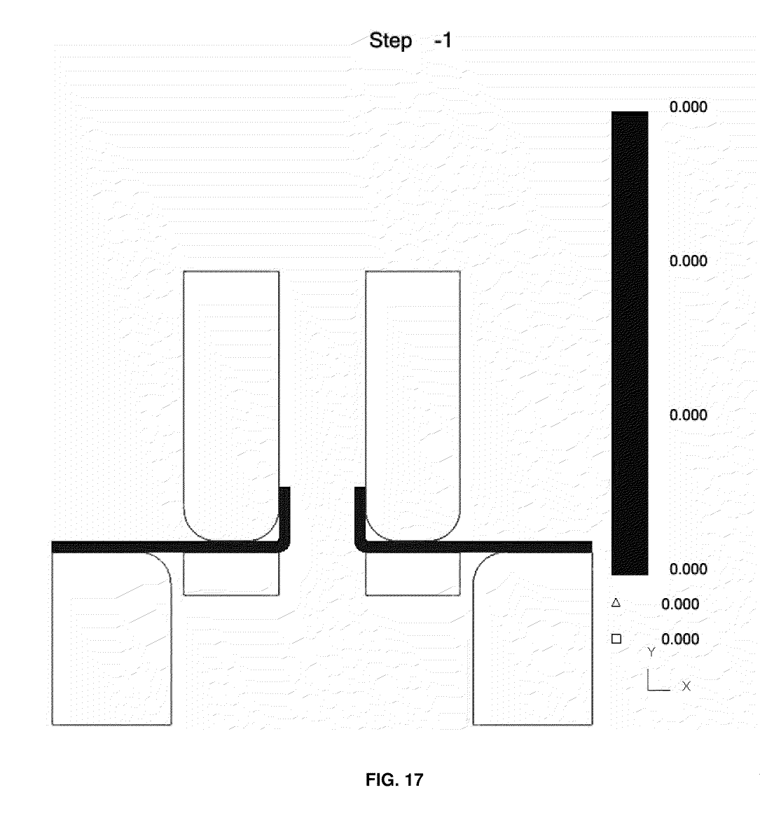

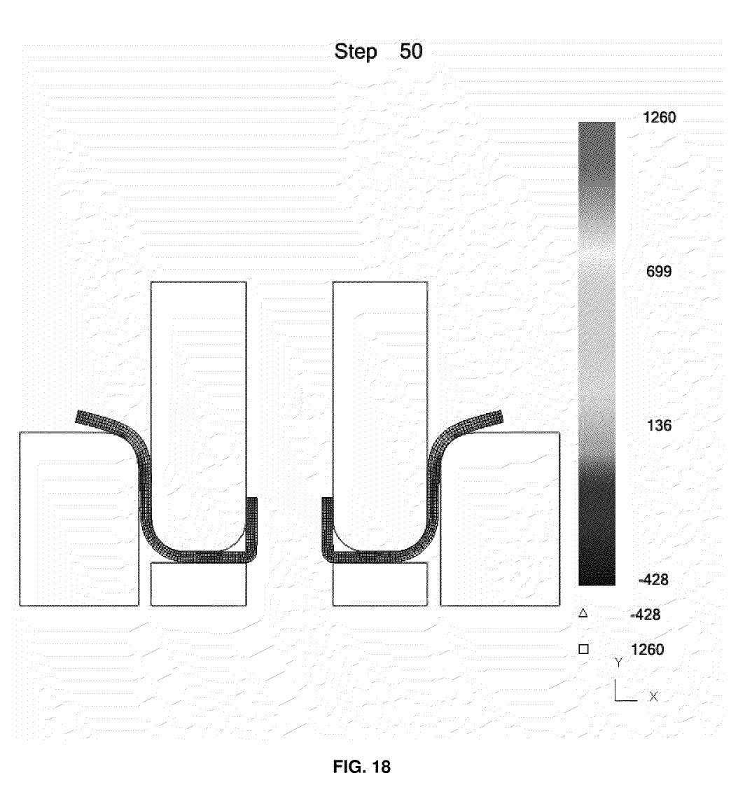

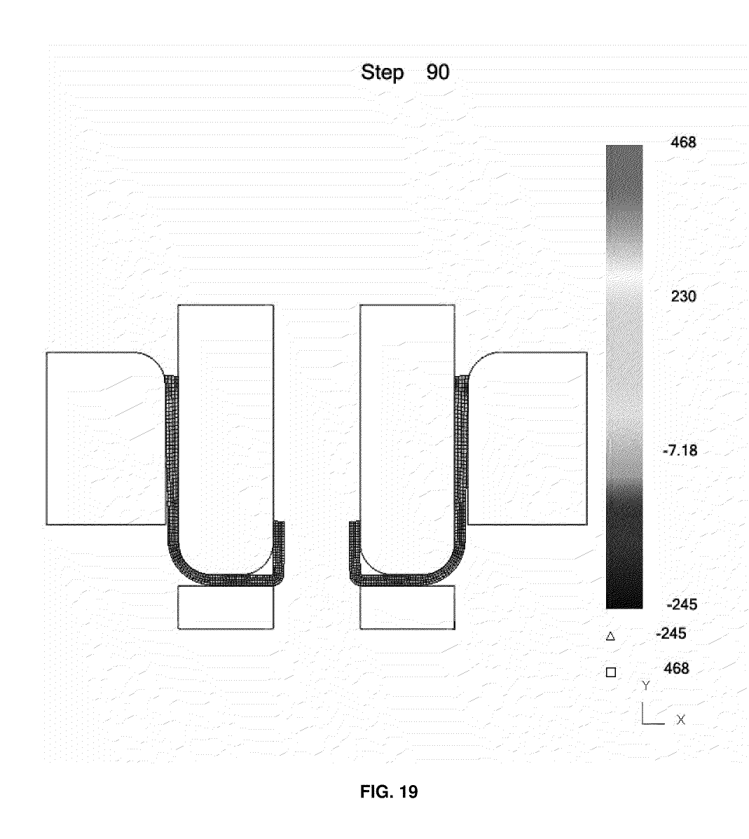

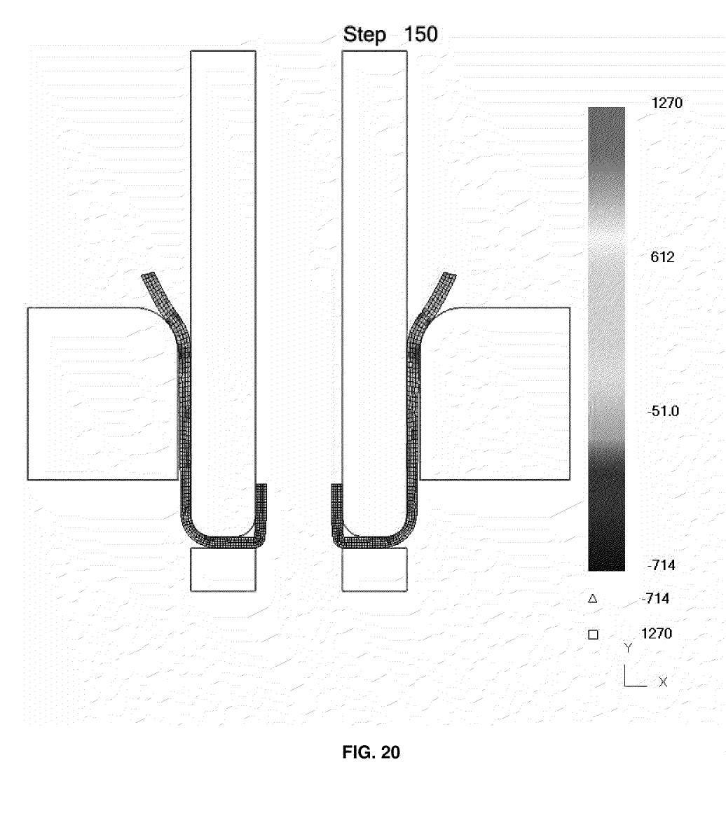

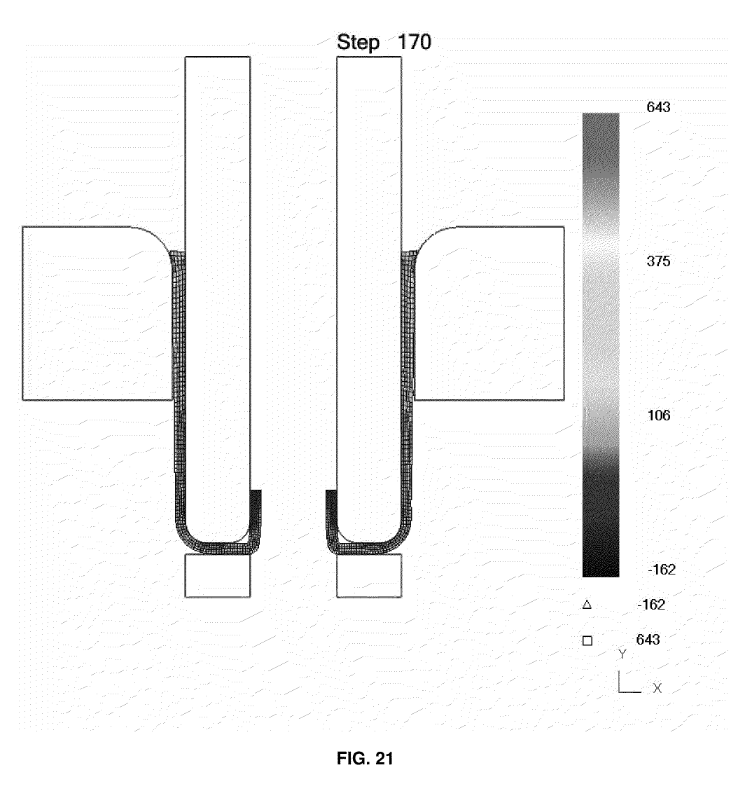

FIGS. 17 to 21 show CAE analysis data by the deep drawing process of the method for fabricating the coupling boss according to the present invention, wherein the middle step and the completion step of the first drawing process and the middle step and the completion step of the second drawing process are shown. The material formed by the collar drawing process is formed by the deep drawing process to complete a product having the high and thick collar part. Here, the deep drawing is performed several times according to the thickness of the completed product.

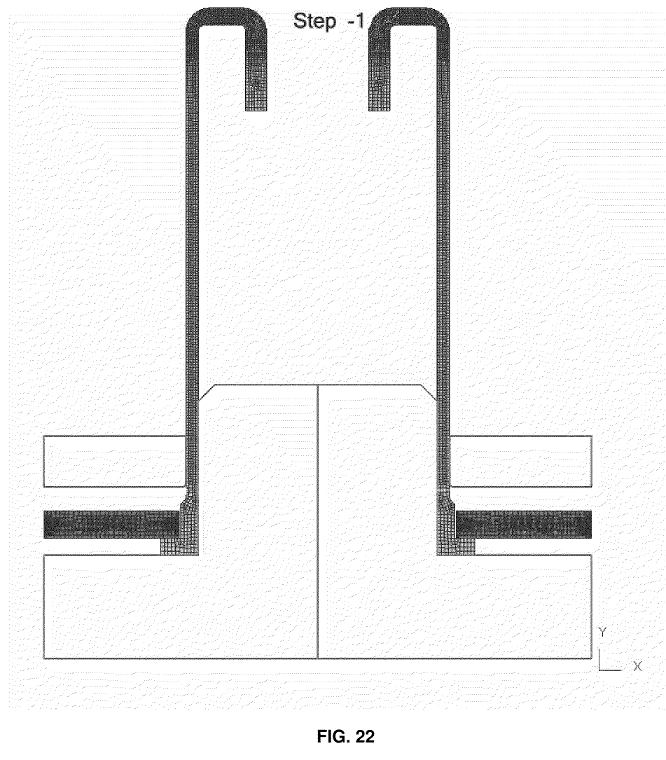

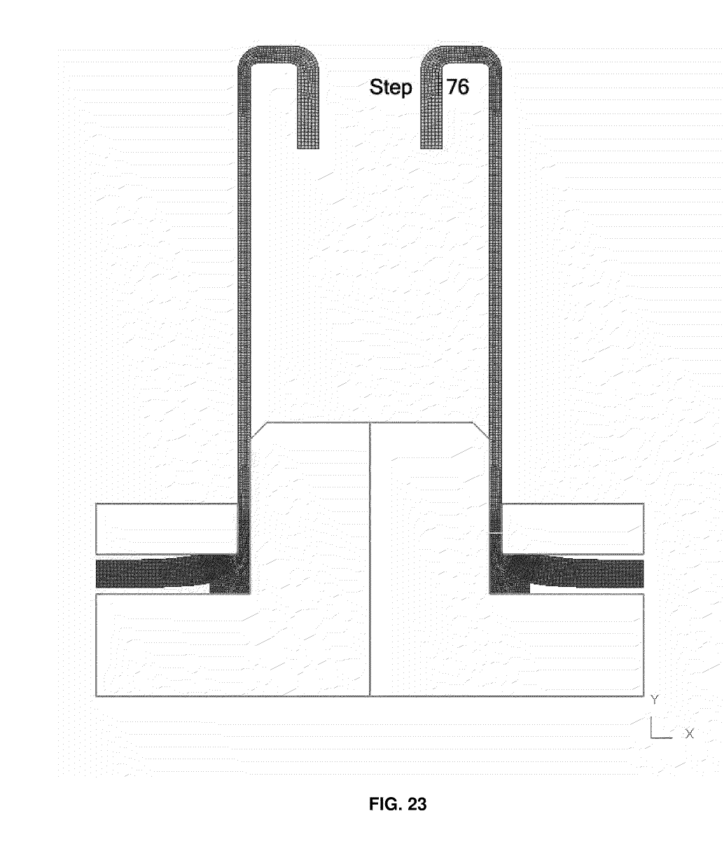

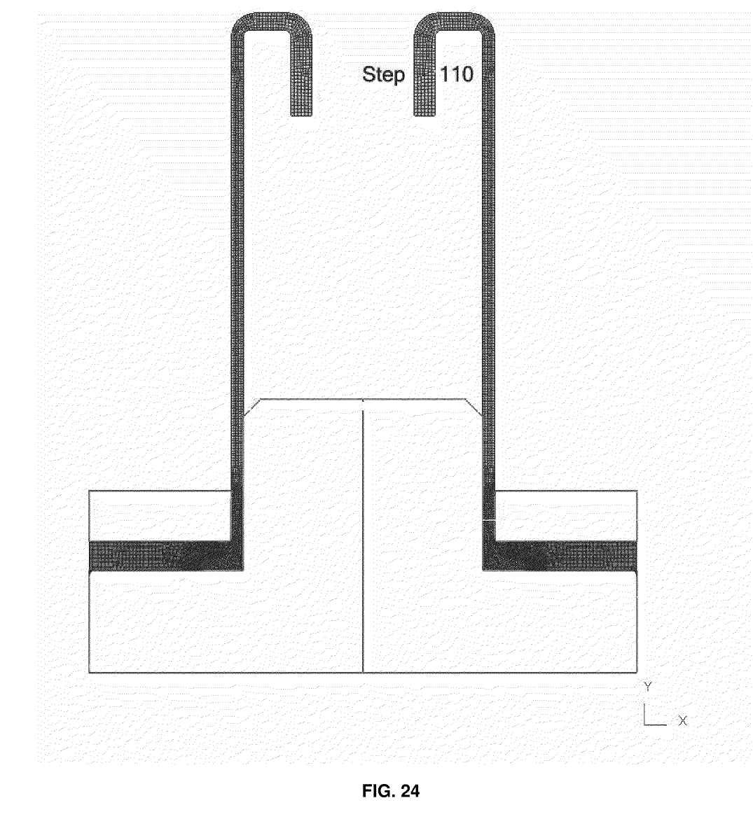

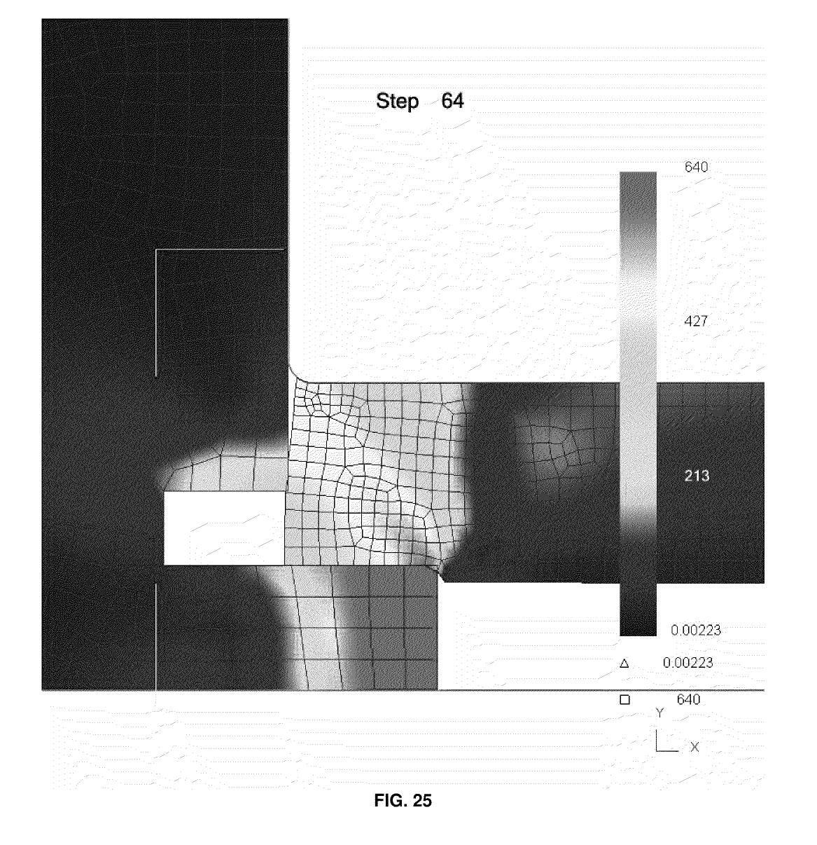

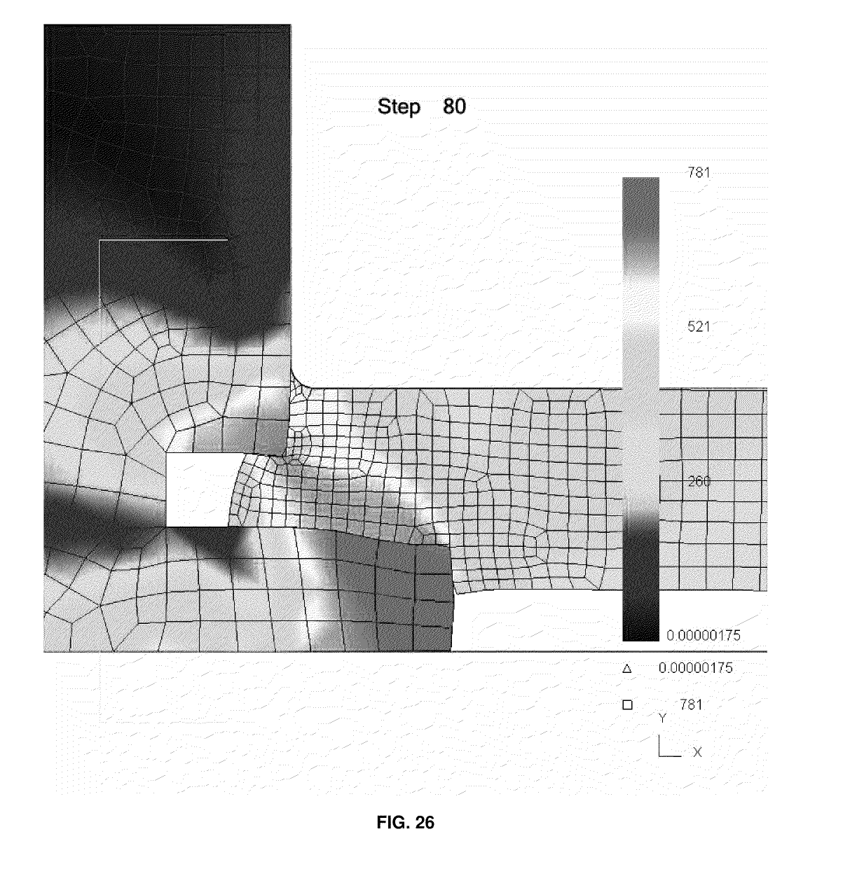

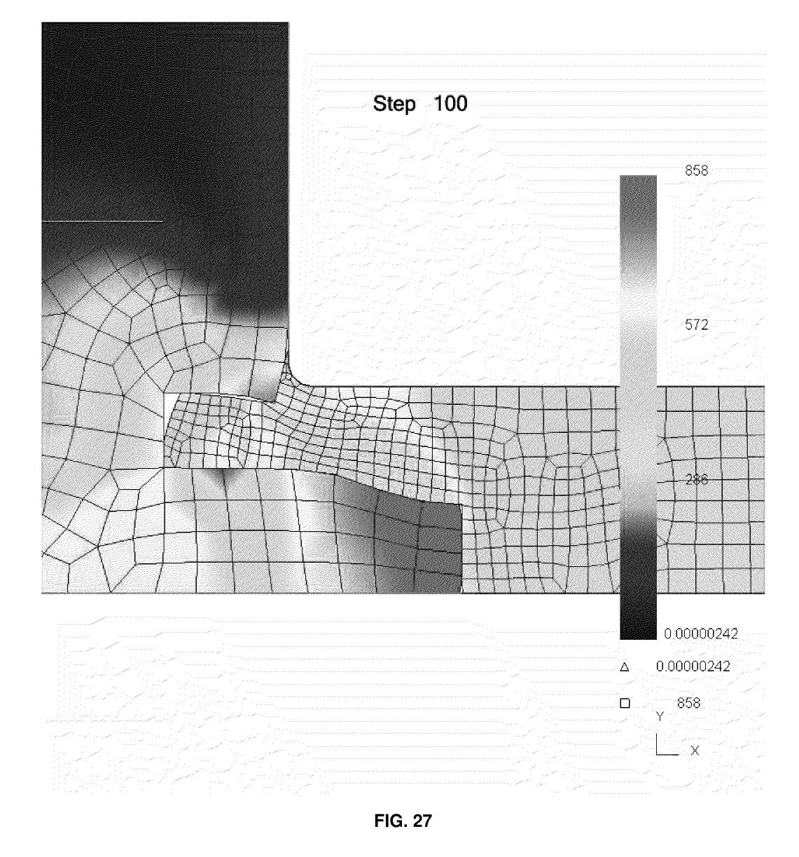

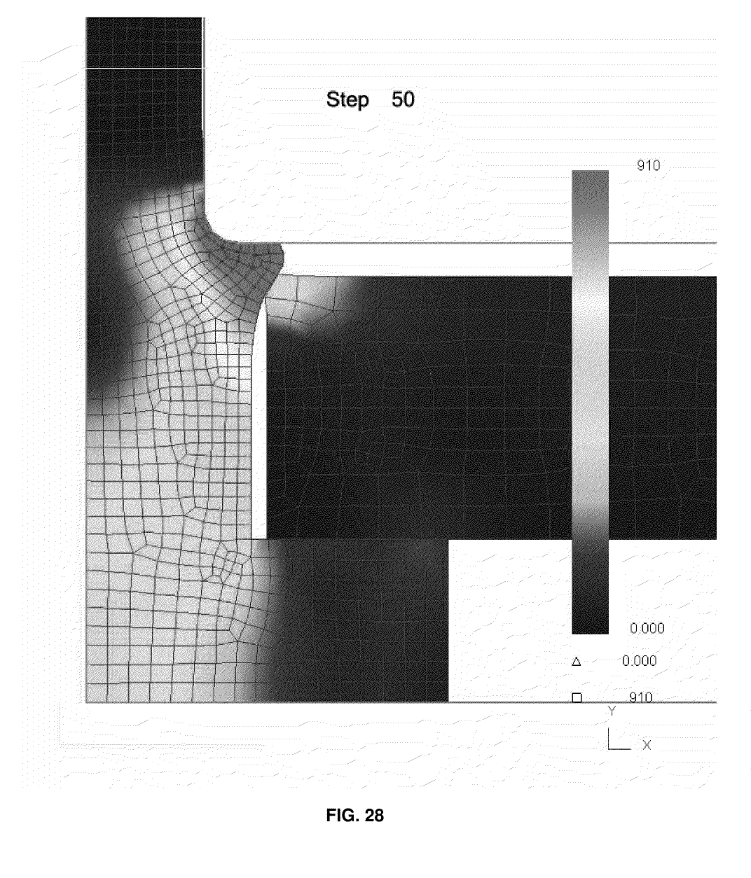

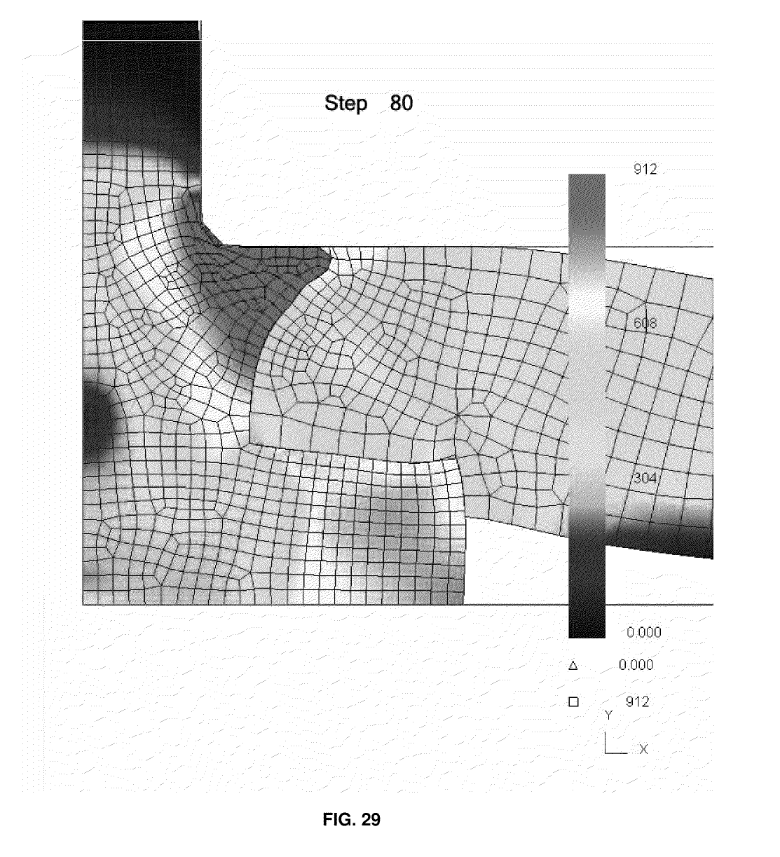

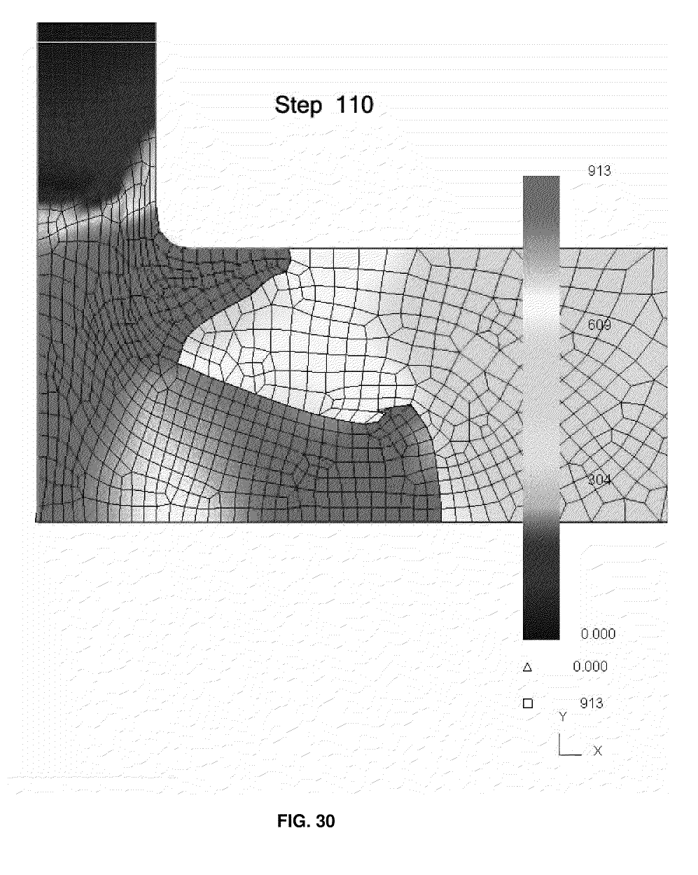

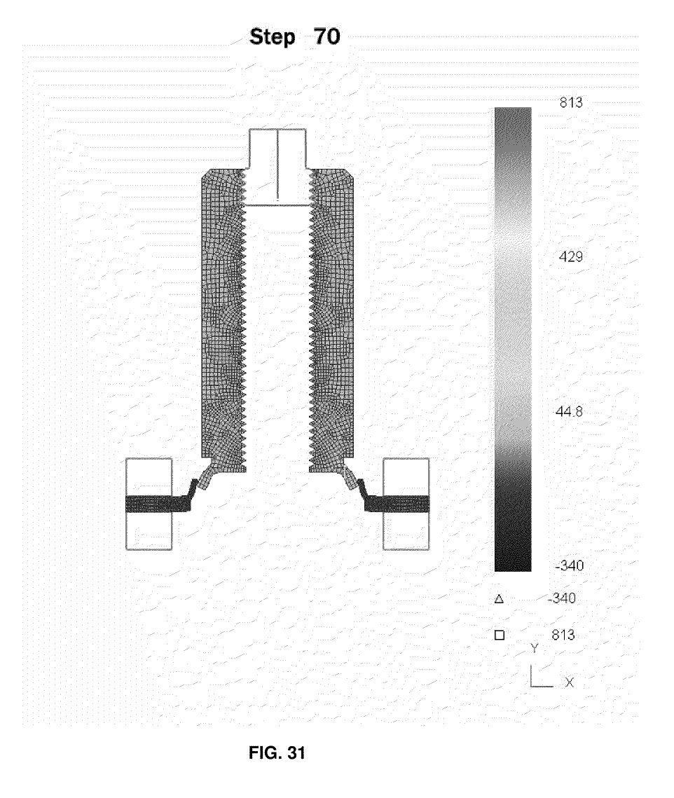

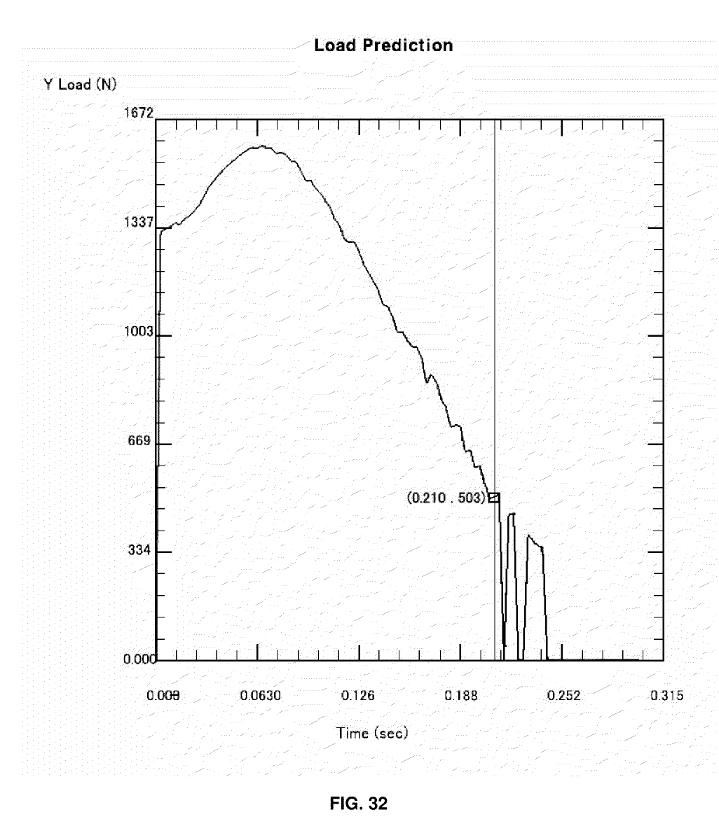

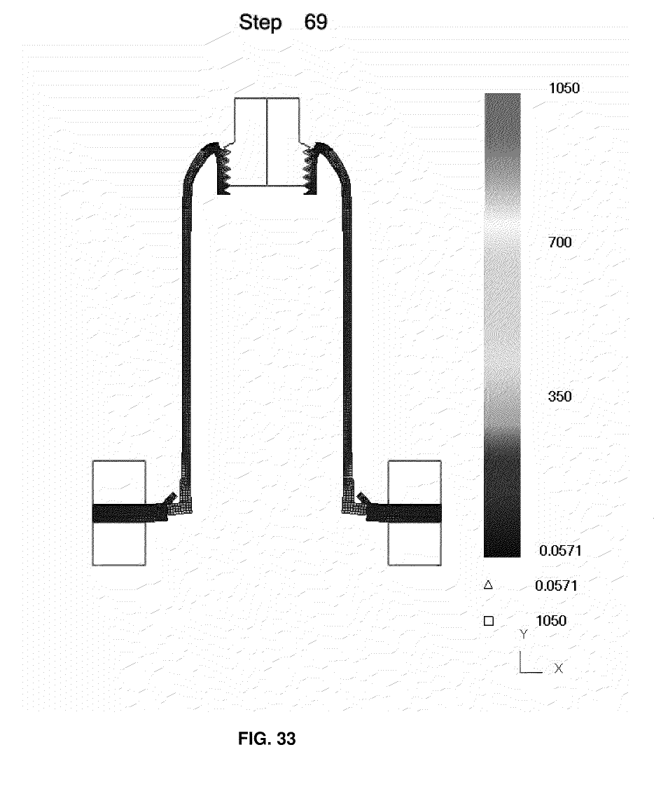

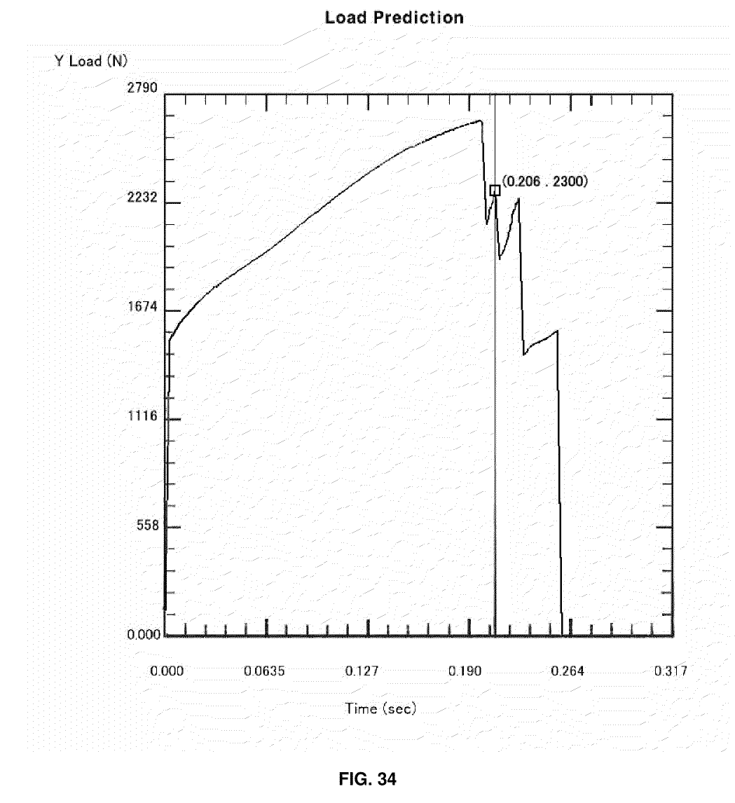

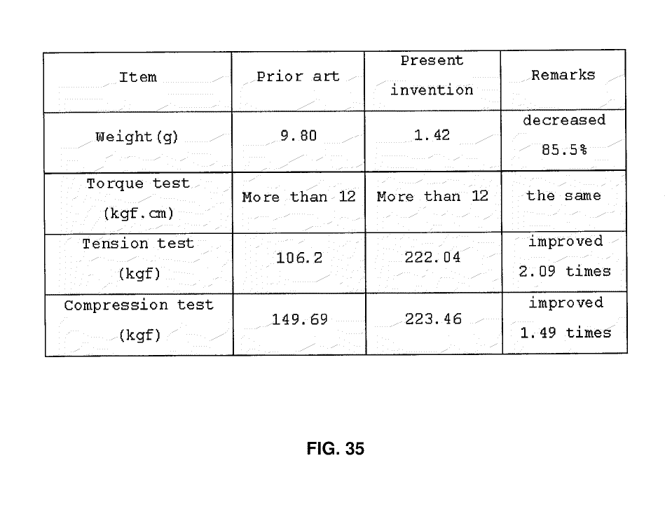

Moreover, FIGS. 22 to 24 are CAE analysis charts of the iron coining process of the method for fabricating the coupling boss according to the present invention, wherein the the first step, the middle step and the final step are shown. In the drawings, the prior art method and the iron coining process of the present invention are compared with each other. In the prior art method, a cut portion becomes weak since a hole is cut to combine the coupling boss with the substrate plate. However, the iron coining process according to the present invention can remove the disadvantage of the prior art method by forming the coupling boss using only plastic working without the machining process. In addition, the iron coining process according to the present invention improves tensile strength about 1.8 times since the prior art method is about 1500N but the iron coining process of the present invention is about 2700N in tensile strength as a result of tension test CAE analysis.

### INDUSTRIAL APPLICABILITY

As described above, according to the method for fabricating a coupling boss, the collar part of the coupling boss is through the collar drawing process using the metal plate material, the screw part is formed through the deep drawing process and the tapping process or through the deep drawing process, the curling process and the tapping process, and then, the coupling boss is combined to the substrate plate passing through the cleansing process, the plating process and the iron coining process in order, whereby the present invention can maximize competitive power in price, miniaturize the coupling boss in size, and maximize tensile strength, compression strength, and surface roughness. Since the curling process is applied to form the screw part 8 of the coupling boss 1, a more stable thickness of the material can be kept.

What is claimed is:

1. A method for fabricating a coupling boss comprising the steps of:
forming a collar part (2) through a collar drawing process for forming a screw part (8) of the coupling boss (1) using a metal plate material;
forming a body part (3) and a flange part (4) on the metal plate material on which the collar part (2) is formed, through a deep drawing process;
tapping the coupling boss (1) to form the screw part (8) on the inner peripheral portion of the collar part (2);
cleansing and plating the tapped coupling boss (1); and
firmly combining the coupling boss (1) with a substrate plate (5) through an iron coining process.

2. The method for fabricating the coupling boss according to claim 1, wherein the cleansing process includes the steps of pretreatment cleaning the coupling boss with wash liquid and performing ultrasonic cleaning for 20±5 minutes, and after the cleansing process, a drying process is performed at 100±10° C. for 10±1 minutes, and then, a defatting process is performed, and
wherein the defatting process includes a dipping process and an electrocleaning process, a water cleaning process is performed three times after the defatting process, and the water cleaning process is performed three times again after a 5% acid (hydrochloric acid+sulphuric acid) cleaning process is performed.

3. The method for fabricating the coupling boss according to claim 1, wherein the plating process is an electroless plating, and includes the steps of digging the coupling boss in a plating bath for 12 to 15 minutes, water cleaning it three times after a visual inspection, water cleaning it three times after a discoloration preventing process, centrifugally drying it at 80±10° C. for 30±5 minutes, and inspecting it.

4. The method for fabricating the coupling boss according to claim 1, wherein the plating process is an acidic zinc plating, and includes the steps of digging the coupling boss in the plating bath for 30 minutes, water cleaning it three times, and water cleaning it three times after a surface controlling process, centrifugally drying it at 80±10° C. for 30±5 minutes, and inspecting it.

5. The method for fabricating the coupling boss according to claim 1, wherein the iron coining process includes the steps of inserting the coupling boss (1) formed by the above fabricating method to the substrate plate (5), putting the substrate plate (5) on a die (6), lowering an iron coining punch (7), and combining the coupling boss (1) and the substrate plate (5) with each other by a complex forming of ironing and coining, and
wherein a clearance (t) between the substrate plate (5) and the coupling boss (1) is kept, an iron coining introduction angle (α) is within the range of 0 to 90°, and an iron coining forming angle (β) is within the range of 0 to 45°.

6. A method for fabricating a coupling boss comprising the steps of:
forming a body part (3) and a flange part (4) through a deep drawing process to form the coupling boss (1) using a metal plate material;
forming a collar part (2) on the body part (3) through a curling process;
tapping the coupling boss (1) to form a screw part (8) on the inner peripheral portion of the collar part (2);
cleansing and plating the tapped coupling boss (1); and
firmly combining the coupling boss (1) with a substrate plate (5) through an iron coining process.

7. The method for fabricating the coupling boss according to claim 6, wherein the curling process is to form the screw part (8) of the coupling boss (1) through the steps of punching the upper end portion of the cylindrical body part (3) of the coupling boss (1), which is formed by the deep drawing process, using a curling punch (9), and inserting a guide punch (10) the moment a curled portion (11) breaks away from a parallel state to a (P) axis to induce that the front end of the curled portion (11) is formed in a parallel direction to the (P) axis.

8. A coupling boss comprising:
a collar part (2) formed by the first collar drawing process to form a screw part (8) of the coupling boss (1) using a metal plate material;
a body part (3) and a flange part (4) formed on the metal plate material, on which the collar part (4) is formed, by a deep drawing process;
a screw part (8) formed on the inner peripheral portion of the collar part (2) by a tapping process; and
a substrate plate (5) firmly combined to the tapped coupling boss (1) by cleansing, plating and iron coining processes.

9. A coupling boss comprising:
a body part (3) and a flange part (4) formed by the first deep drawing process to form the coupling boss (1) using a metal plate material;
a collar part (2) formed on the body part (3) by a curling process;
a screw part (8) formed on the inner peripheral portion of the collar part (2) by a tapping process; and
a substrate plate (5) firmly combined to the tapped coupling boss (1) by cleansing, plating and iron coining processes.
